(19) United States
(12) Patent Application Publication
(10) Pub. No.: US 2002/0156640 A1
(43) Pub. Date: Oct. 24, 2002

(54) Instrumentation of a paper diary to create an objective record of events

(76) Inventors: Michael R. Hufford, Pittsburgh, PA (US); Saul Shiffman, Pittsburgh, PA (US); David Peterson, Scotts Valley, CA (US); J. Corey Harmon, Pittsburgh, PA (US)

Correspondence Address: LAHIVE & COCKFIELD, 28 STATE STREET, BOSTON, MA, 02109, US

(21) Appl. No.: 09/840,730

(22) Filed: Apr. 23, 2001

(51) Int. Cl. G06F 17/60

(52) U.S. Cl. 705/1

(57) ABSTRACT

A device for monitoring subject compliance comprising an instrumented paper diary for subjects to record clinical trial data. The instrumented paper diary creates an objective record of the use of the diary to verify subject entries, allowing researchers and clinicians to systematically track the use of the diary in the field. Subjects record clinical trial data in a paper diary. Electronic instrumentation connected to the paper diary allows use of the diary (e.g. when it was opened and closed) to be unobtrusively tracked, recorded and evaluated against how research protocols dictate the diary to be used. The instrumented paper diary creates an objective electronic record of when the diary was being opened/closed or written upon, allowing researchers to confirm whether the date and time written on diary entries correspond to reported diary use. The handwritten entries in the diary can be checked against the electronic record of when the diary was in use to confirm that the person completed the diary entry when they recorded that they completed it. A variety of different types of instrumentation can be used to collect a variety of data regarding the diary use; including whether it is opened, closed, left open for a long period of time, or being carried with people throughout the day.

### FIELD OF THE INVENTION

The present invention relates to a diary for recording information. More particularly, the present invention relates to a diary for recording information in a clinical trial and monitoring subject compliance with research and medical protocols.

### BACKGROUND OF THE INVENTION

Healthcare practitioners and clinical researchers often ask patients about their health experiences, for example, about their pain, fatigue, eating and drinking, disease-specific symptoms, and overall health, in order to render diagnoses and prescribe treatment or to study disease and treatment. Questionnaires and interviews are the most common way to collect health-related autobiographical information. Apart from the rare intentional deception, self-reports about current states tend to be reliable ways to gather information.

A large body of empirical evidence confirms that relying on memory to recall data is inaccurate and biased. For example, patients' state at the time of assessment and recall can bias their recall of past experience.

Paper diaries (in which people are asked to make notes or entries by writing on paper sheets or cards) are frequently used in both research and clinical settings as a way to collect information from people in the field. Paper diaries are often used in the collection of patient experience data, including data about medical symptoms, subjective states, and patient behavior. For example, people may be asked to complete diary entries daily, or several times per day. Common examples of the use of paper diaries include asking people to record the number of target events (e.g., headaches) that they experience each day, the type and amount of food they consume at meals, whether a medication is alleviating symptoms of an illness, whether they have followed through on some scheduled behavior (initiating a conversation) or activity (physical therapy exercises) prescribed by a health care provider, etc. Paper diaries limit recall and capture experiences close in time to events of interest, and are therefore thought to produce more accurate and unbiased data.

It is particularly important that clinical trials collect valid, reliable data on one or more conditions within a clinical trial group of subjects. Subjects in clinical trials are assigned tasks related to treatment and data collection in accordance with a research protocol. Typically, subjects are given a paper diary and asked to make scheduled entries regarding their illness, medication effects, as well as other data entries recording events as they happen. Subjects must keep track of the time of day, where they are in the sequence of events for any given day, and the appropriate procedures they are to follow across days. The integrity of clinical trials rests upon subjects' faithful performance of the assigned tasks. If subjects fail to comply with the protocol, the trial will fail to yield reliable, valid trial data or results. Thus, subject noncompliance in clinical trials is a significant risk and cost to the pharmaceutical industry. Accordingly, accurate measurement of noncompliance and encouragement of subjects to adhere to research protocols are of substantial value to clinical research.

Noncompliance with research protocols can be especially problematic and can potentially result in unusable trial data. For diaries to accurately reflect experience and effectively reduce bias inherent in retrospective recall by a trial participant, entries in the diary need to be completed close in time to the phenomena they are intended to capture. One major disadvantage of paper diaries is the tendency of subjects to not be truthful or conscientious in keeping their diaries. Many subjects do not complete their diaries or often retrospectively complete their many diary entries at one time, long after the events occur. Patients may fail to complete diary cards as instructed, and they may fake or back-fill written entries so as to give the appearance of good compliance. This undermines the purpose of collecting diary data, as people now must rely on their memory to aggregate events and recall details of events long after they have occurred. Moreover, using a typical paper diary, it is impossible to assess whether or not the diary was completed as required. While estimates of compliance with paper diaries have been high, these estimates have been based upon participants unconfirmed recordings of when they completed diaries, which might not be accurate. Often, a dramatic difference between subjects' reported versus actual compliance exists.

The rationale for use of diaries is sound but is undermined if patients fail to comply with the diary protocol and, in particular, if patients fail to complete the diaries in a timely way. If patients are not compliant with diary protocols, then the original objective of reducing retrospective reporting bias is not achieved.

The benefits of a system that can track and enhance subject compliance in a clinical trial include: reliable, valid data; increased statistical power, reduced clinical trial costs through smaller sample sizes; reduced time to complete the clinical trial; and, ultimately, reduced time and overall cost to get a drug or medical device to market.

### SUMMARY OF THE INVENTION

The present invention concerns a device for monitoring subject compliance in a clinical trial. The illustrative embodiment of the invention comprises an instrumented paper diary for subjects to record clinical trial data. The instrumented paper diary creates an objective record of the use of the diary to verify subject entries, allowing researchers and clinicians to systematically track the use of the diary in the field. Subjects record clinical trial data in a paper diary. Electronic instrumentation connected to the paper diary allows use of the diary (e.g. when it was opened and closed) to be unobtrusively tracked, recorded and evaluated against how research protocols dictate the diary to be used. The instrumented paper diary creates an objective electronic record of when the diary is opened/closed allowing researchers to confirm whether the date and time written on diary entries correspond to reported diary use. The handwritten entries in the diary can be subsequently checked against the electronic record of when the diary was in use to confirm that the person completed the diary entry when they recorded that they completed it. A variety of different types of instrumentation can be used to collect a variety of data regarding the diary use; including whether it is opened, closed, left open for a long period of time, or being carried with people throughout the day.

According to one embodiment, the instrumented paper diary comprises at least one paper form for recording data and electronic instrumentation for generating an electronic record containing information regarding use of the diary.

According to another embodiment, a subject compliance monitoring system is provided. The monitoring system comprises an instrumented paper diary including paper forms allowing a subject to enter data and electronic instrumentation for generating an electronic record of diary use. The monitoring system further comprises an electronic device for displaying and viewing the electronic record

An alternate embodiment of the invention provides an electronic device for monitoring subject compliance in a clinical trial. The electronic device is designed for use with a paper diary and generates an electronic record tracking clinical trial data.

A further embodiment of the invention provides a method of monitoring subject compliance. The method comprises the steps of detecting an event related to data entry in a paper diary for recording data and capturing and storing a characteristic of the event to generate an electronic record of the data entry.

A further embodiment of the invention provides a method of confirming data obtained in a clinical trial. The method of confirming data comprises generating an electronic record containing information regarding use of a paper diary for recording clinical trial data and comparing the electronic record with written clinical trial data in the paper diary.

Yet another embodiment provides a method of monitoring subject compliance in a clinical trial. The method of monitoring comprises providing a subject with an instrumented paper diary for recording clinical trial data and tracking the subject's use of the instrumented paper diary.

According to a final embodiment, a method of making an instrumented paper diary is provided. The method of making the instrumented paper diary comprises providing a paper diary including paper forms for a user to record data and providing electronic instrumentation for tracking use of the diary. The method further comprises connecting the electronic instrumentation to the paper diary to record when the diary is in use.

### BRIEF DESCRIPTION OF THE DRAWINGS

The foregoing and other features and advantages of the invention will be apparent from the following description and apparent from the accompanying drawings.

FIG. 1 illustrates an instrumented paper diary according to an illustrative embodiment.

FIG. 2 is a detailed circuit diagram of the electronics for the instrumented paper diary.

FIG. 3 is a flow chart diagramming the steps involved in generating an electronic record to track use of the diary.

FIG. 4 illustrates a compliance monitoring system including an instrumented paper diary, a reader and a computer for evaluating the entries in the paper diary.

FIG. 5 illustrates an example of an electronic record generated by the instrumented paper diary.

FIG. 6 is a flow chart diagramming the steps involved in transferring the electronic record from the instrumented paper diary to the computer for evaluating the entries.

FIG. 7 illustrates the instrumented paper diary according to an alternative embodiment.

FIG. 8 illustrates the instrumented paper diary according to another embodiment.

### DETAILED DESCRIPTION OF THE ILLUSTRATIVE EMBODIMENTS

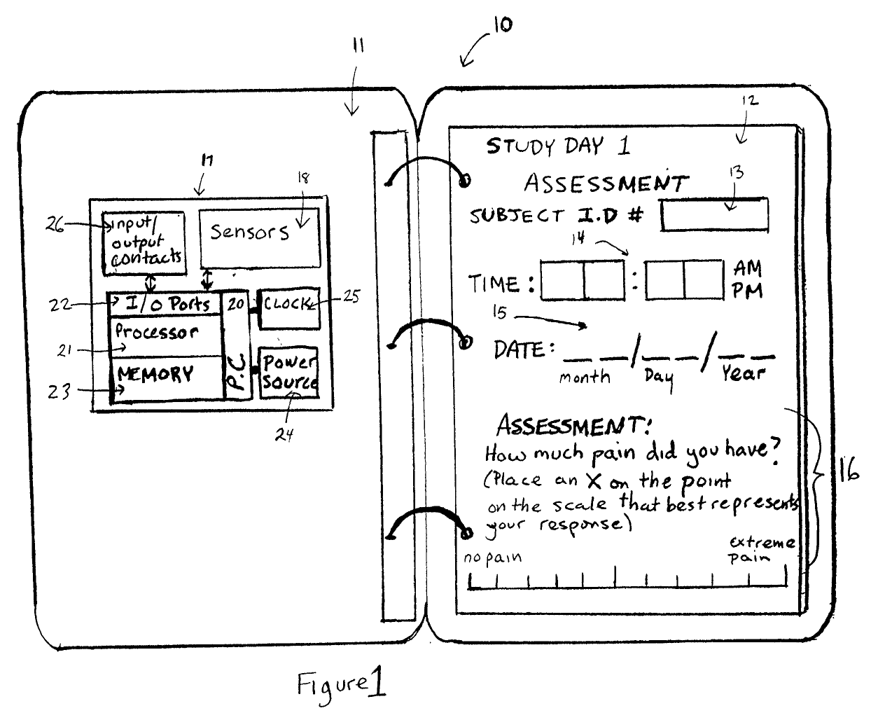

FIGS. 1 through 5, wherein like parts are designated by like reference numerals illustrate an example embodiment of an instrumented paper diary designed to track and verify subject compliance with protocol requirements and provide evaluability data related to subject performance in the clinical trial. Although the present invention will be described with reference to an illustrative embodiment shown in the figures, those skilled in the art will appreciate that the present invention may be implemented in a number of different applications and embodiments and is not specifically limited in its application to the particular embodiment depicted herein.

As used herein “clinical trial” refers to a broad range of data collecting activities, including studies directed to monitoring of one or more conditions within a research project group of subjects. One such example includes drug trials involving humans. As used herein “subject” refers to any participant in a clinical trial, whether or not the subject has any relationship to a doctor or other medical professional.

“Trial data” or “clinical trial data” refers to data gathered for the principle purpose of the clinical research. For example, trial data would include pain levels experienced by subjects in a pain medication clinical trial or craving levels in an anti-smoking medication clinical trial.

“Compliance” refers to adherence to instructions or research protocols. For example, if a clinical trial study requires subjects to record trial data in a diary at particular times, compliance is defined as making a diary entry within a window of time surrounding the designated time for an entry.

“Evaluability data” or “compliance data” or “compliance information” is data that relates to the circumstances under which the trial data was collected or other data pertaining to characteristics of the trial data. Some examples include timeliness, consistency with other collected data, proximity of the data to an expected data range, completeness of the data and whether the data was collected according to instructions.

The illustrative embodiment of the invention incorporates instrumentation in a paper diary to allow the use of the diary (e.g., when it is opened and closed) to be electronically tracked, recorded, and evaluated against a subject's reported use of the diary. The illustrative embodiment involves adding unobtrusive electronic instrumentation to the paper diary so that each open/close of the diary triggers an electronic record to be written to a computer file containing the time and date of the event. The use of the diary can also be evaluated against protocol requirements, i.e., how a user is instructed to use the diary. By creating an objective data stream of when the diary is opened/closed, it is possible to confirm whether the date and time written on diary entries correspond to the reported diary use. In other words, the handwritten entries in the diary can be checked against an electronic record of when the diary was in use to confirm that the person completed the diary entry when they recorded that they completed it. A variety of different types of instrumentation can be used to collect a variety of data regarding the diary use; including whether the diary is opened, closed, left open for a long period of time, or being carried with people throughout the day.

The illustrative embodiment of the invention provides a paper diary with sensors that detect, either mechanically (e.g., the opening of the hasp of the diary, removal of the pen, pressure sensor in pen or under the paper, etc) or optically (e.g., using photosensors to detect changes in light levels, motion sensor, etc) when the diary has been opened, when it has been closed and/or when it has been written on. When these sensors detect an event, a change in the date and/or the time is captured and stored in memory. These saved time-stamped records can be transferred to other computers/databases for further processing (e.g. via a serial cable, Ethernet, or a wireless connection in real time or non-real time, etc).

With reference to FIG. 1, an illustrative embodiment of the instrumented paper diary is shown. The diary 10 includes a binder 11 containing paper forms, illustrated as pre-printed paper diary cards 12, for recording clinical trial data. The diary cards 12 include boxes or spaces to allow a subject to enter information for a clinical trial related to pain. As shown, the subject enters a subject identification number in box 13. The subject enters the time of the assessment in boxes 14, and the date of the assessment in space 15. The assessment space 16 includes a question and room for the subject to enter a response. The illustrative instrumented paper diary 10 is used to evaluate pain levels for a subject at predetermined intervals throughout a clinical study on pain. As illustrated the assessment space 16 asks a user to record a pain level at a particular time. However, the invention is not limited to the illustrated paper diary for recording pain and can comprise any format used to record information related to any number of subjects. Furthermore, the invention is not limited to the illustrated loose-leaf three-ring binder 11, and can comprise any suitable arrangement for recording information, such as a legal pad, folder, file and the like.

The instrumented paper diary of FIG. 1 further includes electronic instrumentation 17 connected to the paper diary binder 11. The electronic instrumentation provides an objective record of when the diary is in use for researchers and/or clinicians to objectively determine the validity of the data written in the diary. The electronic instrumentation functions to track the use of the diary over a period of time and provide unambiguous data on the time and date of when a subject uses the diary. The electronics include a detector circuit comprised of a sensor element 18 for detecting an event or characteristic indicative of use of the paper diary. For example, the illustrated sensor element detects when a user opens and/or closes the diary. The electronics 17 further include a microcomputer comprising a programmable chip 20. The programmable chip includes a microprocessor 21, input/output ports 22, and memory 23. The sensor element 18 generates a signal in response to the event or characteristic indicative of use of the diary. The signal is sent to the microprocessor 21 on the programmable chip 20 via the input/output ports 22. When the programmable chip determines that an event has occurred indicative of use of the diary, the chip 20 records the time and date and writes an electronic record to a computer file containing information regarding a subject's use of the diary. The invention is not limited to a computer file for storing the electronic record. According to alternate embodiments, the storage element comprises a buffer, a linked list of records, or other suitable storage means.

According to the illustrative embodiment of the invention each open/close event of the diary triggers an electronic record to be written to a computer file containing the time and date of the event. For example, if a subject opens the diary at 10:06 a.m., the sensor element 18 generates a signal indicating that the diary is open. The microprocessor recognizes that an “open” event has occurred, and logs the “open” event, and the time and date of the event in the electronic record. The electronic record is stored in memory 23. The programmable chip also includes a power source 24, such as a battery, and a clock 25. The electronics 17 further include input/output contacts 26. The input/output contacts 26 allow a user to program the electronic instrumentation and download information stored in the programmable chip memory to a personal computer or other electronic device for assessment and review. Alternatively, the microprocessor logs and stores the time of the event only. According to alternate embodiments, the microprocessor records how long the diary is opened or closed, but not the absolute times of opening and closing. Those skilled in the art will recognize that a variety of data may be collected related to use of the diary.

According to the illustrative embodiment, a circuit board containing the electronics is covertly inserted into a pocket in the binder and attached to the binder with a hook-and-loop material, such as “VELCRO”. Alternatively, the circuit board may be integrated into an outer casing of the paper diary, in a sheet adjacent to the paper forms in the diary or other suitable location on the diary. Any suitable means for attaching the electronics to the paper diary may be used. In this manner, the electronics are hidden from view or otherwise obscured so that a researcher or health care practitioner can track the use of the diary without the subject realizing that his use of the diary is being monitored.

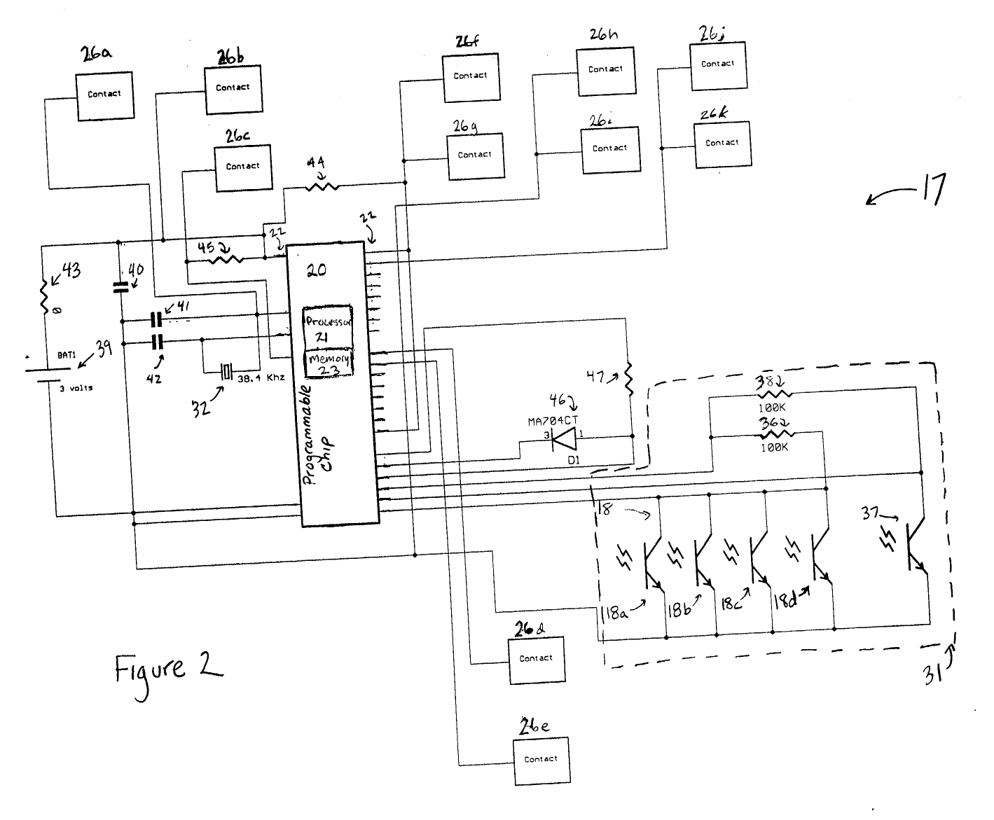

FIG. 2 is a detailed circuit diagram 30 of the electronics 17 of the instrumented paper diary according to the illustrative embodiment of the invention. As discussed, the instrumented paper diary electronics include a detector circuit 31 for monitoring the state of the diary. According to the illustrative embodiment, the detector circuit 31 includes a sensor element 18 comprising a plurality of phototransistors 18a, 18b, 18c, 18d in parallel and a resistor 36. The phototransistors generate an electrical signal in response to light energy. In the illustrative embodiment, a higher light level indicates that the diary is open and potentially in use. When the light level is low, the diary is closed and therefore could not possibly be used to record written data. The phototransistors generate a signal corresponding to the light level and the voltage across resistor 36 varies in proportion to the amount of light energy reaching the phototransistors. A fifth phototransistor 37 in series with a resistor 38 detects when a subject has tampered with the electronics. The four phototransistors 18a, 18b, 18c, 18d are positioned to be exposed to light when the binder opens. However, the fifth phototransistor 37 can only be exposed if a subject removes the covertly hidden electronics from the back flap of the binder for the instrumented paper diary. When a change in the signal generated by the fifth phototransistor 37 is detected, the processor 20 logs a “tamper” event and time-stamps the tampering event. In this manner, the researcher or health care practitioner can identify when a subject has tampered with and/or discovered the covertly hidden electronics. According to the illustrative embodiment, the resistors 36 and 38 have a value of one hundred kilohms.

The microprocessor receives input from the detector circuit and is programmed to recognize a diary state represented by the signal generated by the detector circuit 31. For example, a low signal from the detector circuit 31 indicates that the light level inside the diary is low, implying that the diary is closed. Conversely, a high signal indicates that the light level is high, implying that the diary is open and exposed to light. When a subject opens or closes the diary, the light level changes, causing the signal from the phototransistors 18 to change as well. The microprocessor 21 detects the change and recognizes that an event indicative of use of the diary has occurred. In response to each “open” or “close” event, the microprocessor 21 logs and time-stamps the event. The microprocessor 21 continually monitors the signal from the detector circuit 31 to determine if a change in the current state of the diary has occurred, (for example, if the diary has gone from open to closed or vice versa). When an open or close event occurs, the microprocessor 21 writes an entry in the electronic record and stores the electronic record in memory 23, such as non-volatile RAM. The microprocessor includes an analog-to-digital converter (not shown) to convert the continuously variable signal from the detector circuit into digital values. According to the illustrative embodiment, a three-volt battery 24 in series with a resistor 43 is used to supply power to the electronics. Capacitors 40, 41, 42 form part of the voltage circuit to power the programmable chip 20. A crystal clock 25 controls and synchronizes the timing of the processor and other electronic elements. A diode 46 in series with a resistor 47 is used to set a voltage pin on the programmable chip 20.

The contacts 26a, 26b, 26c, 26d, 26e, 26f, 26g, 26h, 26i, 26j and 26k comprise input/output ports for the electronics. Resistors 44 and 45 are located in series with the contacts and programmable chip 20. Contacts 26a, 26b, 26c, 26d and 26e allow a user to program the electronics. Contacts 26f, 26g, 26h, 26i, 26j and 26k provide a connection to a serial port to allow the electronic record data stored in memory to be transferred to another electronic device, such as a personal computer.

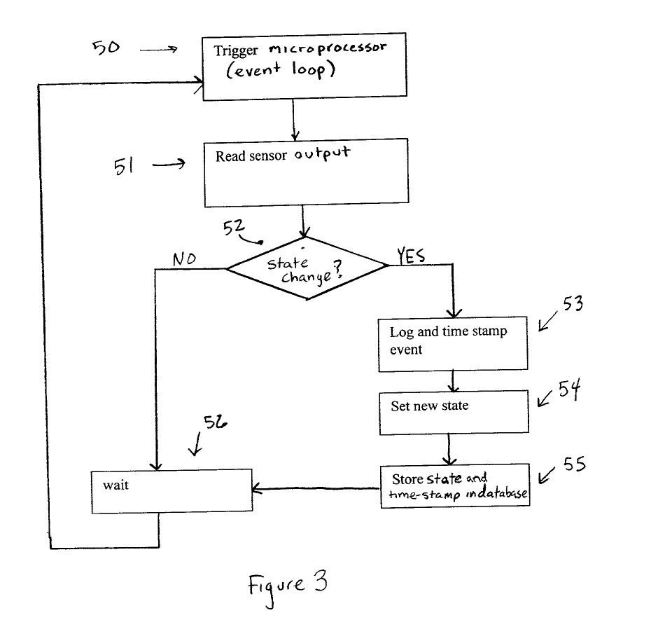

FIG. 3 is a flow chart diagramming the steps involved in generating an electronic record of the diary use. According to the illustrative embodiment, the instrumented paper diary is initialized in a closed state. The microprocessor runs an event loop controlled by a counter to periodically trigger to the microprocessor to measure the signal from the detector circuit (step 50). According to the illustrative embodiment, the event loop triggers the microprocessor every second. In step 51, the microprocessor reads the sensor output indicating a light level. Next, the microprocessor determines if there has been a change in the state of the diary, in step 52. For example, if the diary is initially closed, and the sensor indicates that the diary is now opened, the microprocessor recognizes that the diary is in use. In step 53, the microprocessor logs and time stamps the new state of the diary. For example, if a user opens the diary at 10:06 a.m., the light level reaching the sensors increases. The electronic signal generated by the phototransistors and the voltage across the sensor resistor increase, indicating that an event has occurred relating to use of the diary. In step 54, the microprocessor sets the current state (opened) and stores the state and time-stamp in a database in step 55. For example, the microprocessor stores the entry “Open 10:06 a.m. Oct. 20, 2010” in the chip memory. The microprocessor then waits for the next count to trigger the event loop (step 56). If the microprocessor determines in step 52 that there is no change in the state of the diary, no action is taken and the microprocessor waits for the next trigger (step 56). A subsequent entry will be written in the electronic record when the user closes the diary. As illustrated, the microprocessor constantly monitors the state of the diary and only writes a time-stamped electronic record if the sensors detect an event or characteristic that indicates use of the diary.

FIG. 4 illustrates a compliance monitoring system 60 including the instrumented paper diary 10 for evaluating subject compliance with research protocol. The compliance monitoring system further includes a reader 61 and a personal computer 62 for viewing and assessing the electronic record of diary use. The reader 61 includes a connection cable 63 that runs from the reader to a serial port 64 on the personal computer 62 to upload the electronic record stored in the instrumented paper diary memory to the personal computer 62. The reader 61 includes contacts (not shown) corresponding to the contacts 26f-26k on the instrumented paper diary electronics to transfer data from the instrumented paper diary 10 to the personal computer. The reader 61 comprises a level converter to change the output levels from the instrumented paper diary to a suitable input level for the personal computer. The personal computer 62 contains software 67 for uploading the compliance data in the electronic record, as well as formatting, viewing and storing the compliance data.

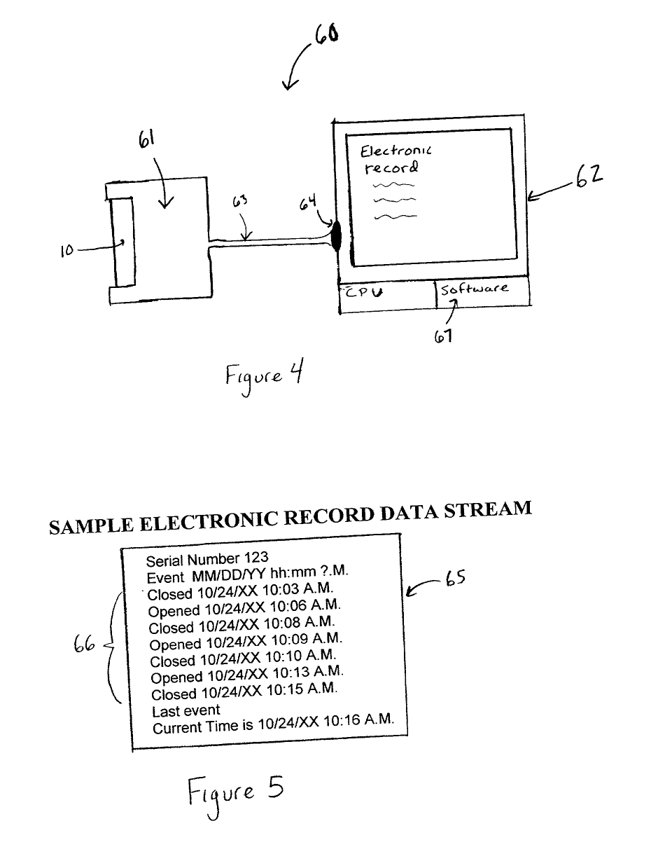

An example of an electronic record generated by the instrumented paper diary and viewed by the computer 62 is illustrated in FIG. 5. The illustrated electronic record 65 comprises an array of data elements, includes the subject identification number in the first line and an explanation for the time-stamped entries in line two. Lines 3-9 list the time-stamped events 66 in the order of occurrence. Each entry includes the event (whether the diary was being opened or closed) followed by the date of the event and the time of the event. Line 11 specifies the date and time when the electronic record is downloaded for viewing.

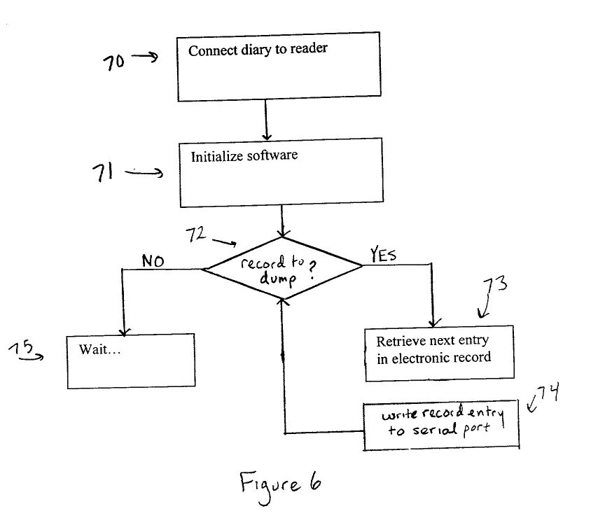

FIG. 6 is a flow chart of the steps involved in transferring the recorded compliance data from the instrumented paper diary to a serial port on the remote computer. In step 70, a researcher or other person connects the instrumented paper diary to the reader via contacts 36. The reader is connected to the serial port on the personal computer by a cable or other suitable connection means. The researcher initializes software on the personal computer for reading the data in step 71, which instructs the instrumented paper diary to transfer the data stored in the programmable chip memory to the personal computer via the serial port. The software first determines if the programmable chip memory contains an electronic record to dump in step 72. If yes, the software retrieves the first record entry in the array of data elements in step 73. Next, the software writes the record entry to the serial port in step 74. The software then returns to step 72 to determine if the memory contains more data and sequentially transfers all data stored in the instrumented paper diary memory. If the memory contains data to dump, the software continues to run the loop until all data is transferred. When the software determines that the memory contains no data to transfer, the software takes no action (step 75). After all data is transferred, the personal computer displays an electronic record, such as the electronic record illustrated in FIG. 5.

The personal computer 62 of the compliance monitoring system 60 may also be used to clear all of the old data from the instrumented paper diary memory after the electronic record stored in memory has been downloaded. In addition, at the conclusion of a clinical trial, the personal computer software is utilized to place the instrumented paper diary in a power down storage mode to conserve battery power. In this manner, the instrumented paper diary may be used over again with a new subject and/or a new clinical trial.

As described in detail above, the electronic instrumentation in the paper diary allows the time and date of the diary use to be recorded and tracked over time. The electronic instrumentation provides an objective record of when the diary is in use (open/closed) for researchers and clinicians, thus permitting the validity of the data written in the paper diary to be objectively determined. Researchers can perform compliance analyses based on compliance as reported in paper diaries versus the electronically recorded times of diary use by comparing patients' self-reports of diary completion with actual completion times, inferred from the observed pattern of diary openings and closings.

The instrumented paper diary of the illustrative embodiment provides a significant advantage over current paper-based diary systems. The electronic record of when the diary is being used permits an analysis of the veracity of the data to be objectively performed by cross-referencing the electronic time and date stamps with the time and date of paper diary entries as recorded by users in the field. Handwritten diary entries that correspond to an electronic record of use can be considered valid (e.g., a diary record indicates that the subject completed a timed diary entry at 10 am on a specific day, and an electronic record corresponds to a period of use at about 10 am on that specific day), whereas diary entries without any corresponding electronic record can be considered falsified. For example, the instrumented paper diary can easily detect noncompliance on the part of the subject when diary records indicate faithful compliance of 10 am reports each day during a week long monitoring period, but the electronic records show only a single use of the diary before a research or clinic visit. Clinical trial participants may fail to make timely entries then later back-fill missed data all at once in preparation for a visit to the clinic. This practice, known as “hoarding”, “back-filling” or “cramming”, occurs often in clinical trials, and often goes undetected. The instrumented paper diary allows researcher to detect when diary entries are fraudulent, thereby facilitating the collected of valid, reliable data.

The described instrumented paper diary can further be embodied in a number of different ways and other information aside from the opening and closing of the diary can be recorded by the instrumentation as well. For example, the instrumented paper diary can be programmed to measure and record the duration of the opening, whether the diary was left open or was subsequently closed, whether someone was carrying the diary during the day, the amount of the writing that occurred in the diary, etc. The electronic records regarding the diary's use could then be uploaded to a computer.

According to an alternate embodiment of the invention, illustrated in FIG. 7, a pen 80 or other writing device attached to the diary 10 is instrumented with sensors 18 and other electronics 17 to create the aforementioned electronic record. When the sensor located on the writing device detects that the writing device is in use, the sensor triggers an electronic record of the time and date of the writing.

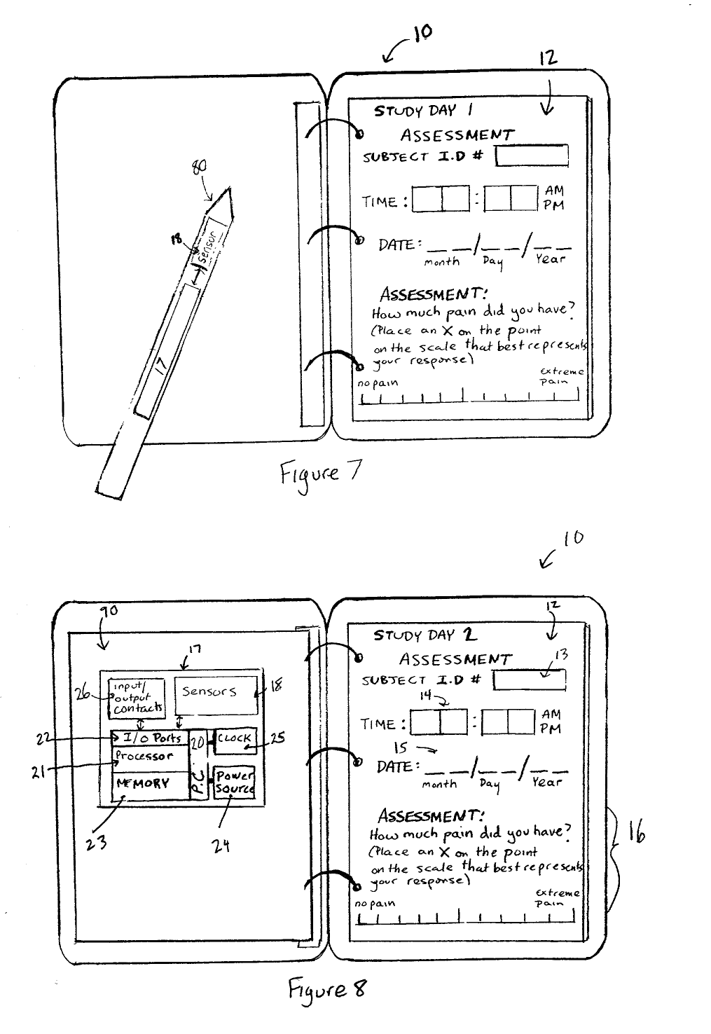

According to another embodiment, illustrated in FIG. 8, a writing surface 90 of the paper diary is instrumented to detect the act of writing and generate an electronic record of the time and date of the writing.

According to yet another embodiment, sensor element 18 in FIG. 1 comprises a pedometer, accelerometer, tachometer or other suitable sensors for detecting movement of the diary and generating an electronic record of the movement of the diary throughout a particular time period. The researcher can track whether a subject carries the diary with him throughout the day, or if the subject leaves the diary in one place over an extended period of time. In this manner, the researcher can cross-check whether a subject accurately records information regarding his activities.

While the electronic instrumentation of the illustrative instrumented paper diary is covert, i.e., hidden from view or otherwise obscured, the electronic instrumentation may also be overtly attached to the paper diary, i.e. in plain sight of the subject, and/or may provide to the subject some explicit indication that a recording is being made, including feedback on compliance. Covert instrumentation allows researchers to retrospectively evaluate and determine the validity of collected data. Overt instrumentation can serve to encourage compliance with research protocols in addition to providing an evaluation of compliance. According to an alternate embodiment, the circuit board containing the electronics for the instrumented paper diary is overtly attached to the binder and includes a graphical display informing the diary user of data kept in the computer file, such as the last time the diary was opened. With overt instrumentation, subjects know that their use of the diary is being tracked, making them more likely to enter accurate entries and also to adhere to the instructions for entering data.

Furthermore, the instrumented paper diary of the illustrative embodiment is not limited to use in clinical trials, and a variety of uses for the instrumented paper diary are possible. The instrumented paper diary is of value to any researcher or clinician that relies on people to faithfully complete their diaries in the field. By allowing researchers to instrument paper diaries and track the use of the paper diaries, investigators are capable of tracking subject compliance, allowing them to evaluate the validity and quality of the data. The instrumented paper diary also has application to dieticians who use food diaries to assess their patients' adherence to various dietary regimens. Similarly, psychotherapists can use the compliance monitoring device to record if patients successfully recorded various exercises prescribed each day (e.g., initiating 2 conversations per day for someone with social phobia). According to another application of the invention, employers can use the instrumented paper diaries to track employees' completion of various tasks in a timely manner. For example, employers could use an instrumented paper diary to ensure that their sales force recorded invoices after each client meeting versus trying to recall them at the end of a business trip.

These examples are meant to be illustrative and not limiting. The present invention has been described by way of example, and modifications and variations of the exemplary embodiments will suggest themselves to skilled artisans in this field without departing from the spirit of the invention. Features and characteristics of the above-described embodiments may be used in combination. The preferred embodiments are merely illustrative and should not be considered restrictive in any way. The scope of the invention is to be measured by the appended claims, rather than the preceding description, and all variations and equivalents that fall within the range of the claims are intended to be embraced therein.

Having described the invention, what is claimed as new and protected by Letters Patent is:

1. An instrumented paper diary for recording data, comprising:
at least one paper form for recording data; and
electronic instrumentation for generating an electronic record containing information regarding use of the diary.

2. The instrumented paper diary of claim 1, further comprising an interface for transferring the electronic record to a computer.

3. The instrumented paper diary of claim 1, wherein the electronic instrumentation includes a sensor for detecting when a subject uses the paper diary.

4. The instrumented paper diary of claim 3, wherein the sensor comprises an optical sensor for detecting when the paper diary is opened.

5. The instrumented paper diary of claim 4, wherein the sensor comprises a sensor to detect changes in light levels.

6. The instrumented paper diary of claim 3, wherein the sensor comprises a mechanical sensor for detecting when a user opens the diary.

7. The instrumented paper diary of claim 3, wherein the sensor detects when the diary is closed.

8. The instrumented paper diary of claim 3, wherein the electronic record captures and stores a time corresponding to when the sensor detects that the subject uses the paper diary.

9. The instrumented paper diary of claim 3, wherein the sensor is located underneath a writing surface of the paper form to detect when a user writes in the diary.

10. The instrumented paper diary of claim 3, wherein the sensor detects movement of the diary.

11. The instrumented paper diary of claim 3, further comprising a tamper sensor for detecting when a subject tampers with the electronic instrumentation.

12. The instrumented paper diary of claim 1, further comprising a pen connected to the diary to allow a user to record data and a time on the paper form.

13. The instrumented paper diary of claim 12, wherein the pen includes a sensor to detect when the user writes in the diary.

14. The instrumented paper diary of claim 1, wherein the electronic instrumentation includes a database to store the electronic record as a computer file.

15. The instrumented paper diary of claim 1, wherein the electronic record captures and stores an event indicative of use of the diary, together with a time at which the event occurs.

16. The instrumented paper diary of claim 15, wherein the electronic record further stores the date at which the event occurs.

17. The instrumented paper diary of claim 15, wherein said event comprises opening the diary.

18. The instrumented paper diary of claim 15, wherein said event comprises closing the diary.

19. The instrumented paper diary of claim 1, wherein the electronic instrumentation is visible to a user of the paper diary.

20. The instrumented paper diary of claim 19, further comprising a graphical display for displaying the electronic record to the user of the diary.

21. The instrumented paper diary of claim 1, wherein the electronic instrumentation is covertly connected to the paper form, such that the electronic instrumentation is hidden from a user of the diary.

22. A subject compliance monitoring system, comprising:
an instrumented paper diary including paper forms allowing a subject to enter data and electronic instrumentation for generating an electronic record of diary use; and
an electronic device for displaying and viewing the electronic record.

23. The subject compliance monitoring system of claim 22, further comprising a reader for transferring the electronic record from the instrumented paper diary to the electronic device.

24. The subject compliance monitoring system of claim 23, wherein the reader includes a cable connectable to an interface port on the electronic device.

25. The subject compliance monitoring system of claim 22, wherein the electronic device comprises a personal computer.

26. A device for monitoring subject compliance in a clinical trial, comprising:
an electronic device for use with a paper diary, wherein the electronic device generates an electronic record tracking clinical trial data.

27. The device of claim 26, further comprising a paper diary in communication with the electronic device for manually recording clinical trial data.

28. The device of claim 27, wherein the electronic device comprises a sensor for detecting when a user records said clinical trial data.

29. The device of claim 28, wherein the electronic record logs a time when the user records said clinical trial data.

30. The device of claim 28, wherein the electronic record logs a date when the user records said clinical trial data.

31. The device of claim 28, wherein the electronic record logs the duration of a time period during which the user records said clinical trial data.

32. The device of claim 28, wherein the electronic record is compared to the clinical trial data in the paper diary to verify the clinical trial data in the paper diary.

33. A method of monitoring subject compliance, comprising:
detecting an event related to data entry in a paper diary for recording data; and
capturing and storing a characteristic of the event to generate an electronic record of said data entry.

34. The method of claim 33, wherein said step of detecting an event comprises detecting when the paper diary is opened.

35. The method of claim 33, wherein said step of detecting an event comprises detecting when the paper diary is closed.

36. The method of claim 33, wherein said step of detecting an event comprises detecting when a subject opens the paper diary.

37. The method of claim 33, wherein the step of detecting an event comprises detecting when a subject closes the paper diary.

38. The method of claim 33, wherein said characteristic comprises a time of the event.

39. The method of claim 33, wherein said characteristic comprises a date of the event.

40. The method of claim 33, wherein said event comprises use of the paper diary to record data.

41. The method of claim 40, wherein said electronic record stores the time and date of the use of the diary.

42. A method of confirming data obtained in a clinical trial, comprising:
generating an electronic record containing information regarding use of a paper diary for recording clinical trial data; and
comparing said electronic record with written clinical trial data in the paper diary.

43. The method of claim 42, wherein the electronic record records a time when a subject uses the diary.

44. The method of claim 43, wherein the subject writes a time corresponding to diary use in the diary.

45. The method of claim 44, wherein said written clinical trial data is considered valid if the time written by the subject corresponds to the time in the electronic record when the subject uses the diary.

46. The method of claim 44, wherein said written clinical trial data is considered falsified if the time written by the subject does not correspond to the time in the electronic record when the subject uses the diary.

47. A method of monitoring subject compliance in a clinical trial, comprising:
providing a subject with an instrumented paper diary for recording clinical trial data; and
tracking the subject's use of the instrumented paper diary.

48. The method of claim 47, wherein the step of tracking the subject's use comprises generating an electronic record of when the subject uses the instrumented paper diary.

49. The method of claim 48, wherein the subject writes the clinical trial data and a time corresponding to the clinical trial data in the instrumented paper diary.

50. The method of claim 49, further comprising the step of comparing the time corresponding to the clinical trial data written by the user with information in said electronic record to confirm whether a time written in the diary corresponds to use of the diary.

51. A method of making an instrumented paper diary, comprising:
providing a paper diary including paper forms for a user to record data;
providing electronic instrumentation for tracking use of the diary; and
connecting said electronic instrumentation to the paper diary to record when the diary is in use.
